(19) United States
(12) Patent Application Publication
(10) Pub. No.: US 2009/0309866 A1
(43) Pub. Date: Dec. 17, 2009

(54) CONTROLLING A MOBILE TELEPHONE RESPONSIVE TO AN ESD EVENT

(75) Inventor: Carl Ziller, Apex, NC (US)

Correspondence Address: SNYDER, CLARK, LESCH & CHUNG, LLP, 754 ELDEN STREET, SUITE 202, HERNDON, VA, 20170, US

(73) Assignee: Sony Ericsson Mobile Communications AB, Lund (SE)

(21) Appl. No.: 12/139,266

(22) Filed: Jun. 13, 2008

(51) Int. Cl. G06F 3/038

(52) U.S. Cl. 345/214

(57) ABSTRACT

Whenever an electrostatic discharge (ESD) event has occurred which may have corrupted the display registers, displays in a mobile telephone are reinitialized. A General Purpose Input/Output (GPIO) device is employed to trigger an interrupt whenever an antenna/detector, connected between the GPIO and a test point proximate the displays, detects the occurrence of an ESD event. The displays may then be checked for corruption and reinitialization of the displays may be performed as necessary.

### TECHNICAL FIELD

The present invention is directed to mobile telephones, more particularly, to a reinitialization of a mobile telephone display after an ESD event.

### BACKGROUND

Mobile communication devices, such as cellular phones and the like, have become increasingly prevalent. These devices provide the convenience of a handheld communication device that is capable of increased functionality. The focus of the structural design of mobile phones continues to stress compactness of size, incorporating powerful processing functionality within smaller and slimmer phones. To further these objectives, various devices have been developed and gained popularity, such as the flip phone, clam shell, slider, jack knife. Components of these devices are distributed within a housing of the phone body and a cover, which are movably coupled to each other. The cover may be in hinged or in slidable engagement with the housing.

Structure of a typical flip, or clam-shell, phone is illustrated in perspective view in FIG. 1. The phone body 100 includes various keypad elements 108, and a microphone (unlabeled), which are located at a surface of the body housing. Additional user control elements, not shown, may be provided at side surfaces of the housing. Within the housing are contained a controller and associated communication hardware, which are situated in one or more circuit boards. The phone body 100 is structurally coupled via hinge (unlabeled) to the cover, or upper portion, 102. At the illustrated surface of cover 102 are a speaker (unlabeled) and displays 106. The cover also includes other elements that are not shown, including an antenna.

The main circuit board and the display are connected via a relatively long flex circuit extending between the two halves of the telephone. Electrostatic Discharges (ESD) near the display may cause the display to reset due to the impedance of the flex circuit. ESD is a common phenomenon and may occur, for example, as a static electricity charge when a user of a mobile telephone walks across a carpeted floor. An ESD may develop a voltage from +/−6 kV to +/−15 kV, or even larger. ESD near the display may cause the display to reset. An ESD voltage in the vicinity of 8,000 volts or more may corrupt the configuration registers of the display and thus the display.

Conventionally, the display registers are continuously polled to check display status to determine whether they have been reset. If a reset has occurred, the display must be reset. However, in mobile telephone devices having a plurality of displays, such continuous polling is not efficient. Accordingly, a need exists for an improved ESD detection and reinitialization technique.

### SUMMARY OF THE DISCLOSURE

A clam-shell type mobile telephone, such as a flip phone or a slider type phone, is provided with a General Purpose Input/Output (GPIO) device, preferably, but not necessarily, located in a lower portion of the clam-shell type mobile telephone, and configured as an input to a long track, or antenna, that terminates, preferably, at the end of a flex circuit in an upper portion of the clam-shell type mobile telephone. This long track, or signal track, acts as an antenna and an ESD detector.

In a preferred embodiment, the GPIO is located in the lower portion of the telephone and on a controller within the processing area of the telephone. The GPIO has a plurality of input pins to provide ease of connection to input and output signals. In particular, the GPIO is positioned on the Baseboard (BB) controller as an input with interrupt when an input pin state change occurs. The GPIO is connected to a voltage divider that acts as a trigger for the interrupt and may, for example, take the form of an RC-network, an RL-network, or a resistive network, that acts to reduce a large transient voltage in the form of an ESD to a more manageable level.

The signal track, acting as an antenna, is connected between the voltage divider as an input to the GPIO, through the connecting flex, to a location where the display, or displays, are located. The track traverses the upper flex/PCB area and is terminated at an embedded test point. The location of the embedded test point is chosen to be at any appropriate location, preferably proximate the display, or displays, and on the distal end of the displays relative to the voltage divider, or trigger network, where an ESD event is likely to occur. Then, ESD events near the display, or displays, cause large transients on the ground plane that couples into the ESD detector track which, in turn, cause the interrupt to trigger on the appropriate GPIO input pin. When such a triggering occurs, the displays can then be checked, or polled, in any well known manner, as by appropriate software, and any displays that may have been reset by the ESD event can then be reinitialized. Reinitialization of the displays may be achieved by powering up the original initialization string applied to the display registers.

In one preferred embodiment, the displays or, more properly, the registers of the displays, are reinitialized whenever an ESD event is detected, regardless of whether any displays were rest by the ESD event.

In another embodiment, in response to the detection of an ESD event, the displays are checked to determine if the ESD event, in fact, has reset at least one of the displays. In this case, the displays are reinitialized only if they had been reset by the ESD event. Not every ESD event will result in the resetting of the displays and in those cases where an ESD event does not result in the resetting of the displays, it is not necessary to automatically reinitialize the display registers.

Additional advantages of the present invention will become readily apparent to those skilled in this art from the following detailed description, wherein only the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

FIG. 1 is a perspective view of a clam-shell type mobile telephone having a plurality of displays.

FIG. 2 is a block diagram illustration of the connection between various elements of the mobile telephone.

FIG. 3 is a more detailed circuit diagram of the mobile telephone configured in accordance with the present disclosure, illustrating the manner of connecting the signal track/antenna.

FIG. 4 is an illustration of the specific connection between the test point, the trigger network and the GPIO.

FIG. 5 is an illustration of several trigger networks that may be employed to connect between the signal track/antenna and the GPIO.

FIG. 6 is an illustration of several trigger networks that may be employed to connect between the signal track/antenna and the GPIO when a double trigger is used as interrupts.

FIG. 7 is a flowchart illustrating an embodiment for controlling the mobile telephone.

FIG. 8 is a flowchart illustrating another embodiment for controlling the mobile telephone.

### DESCRIPTION OF THE PREFERRED EMBODIMENTS

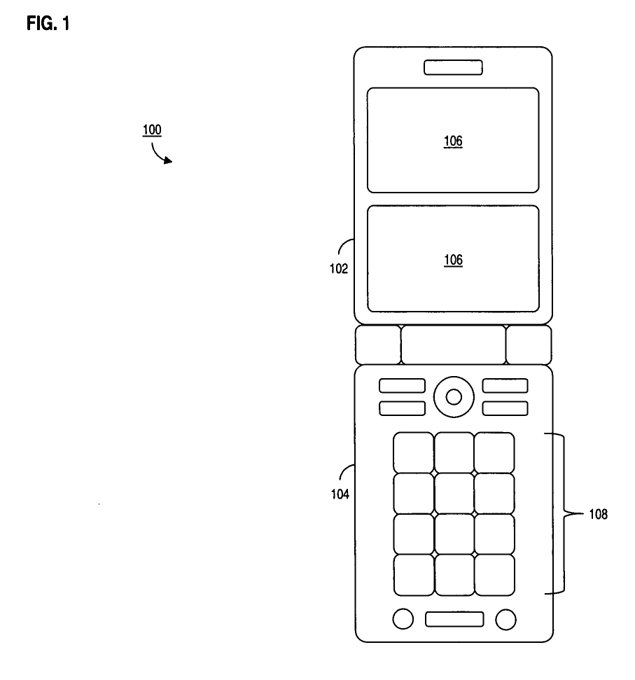

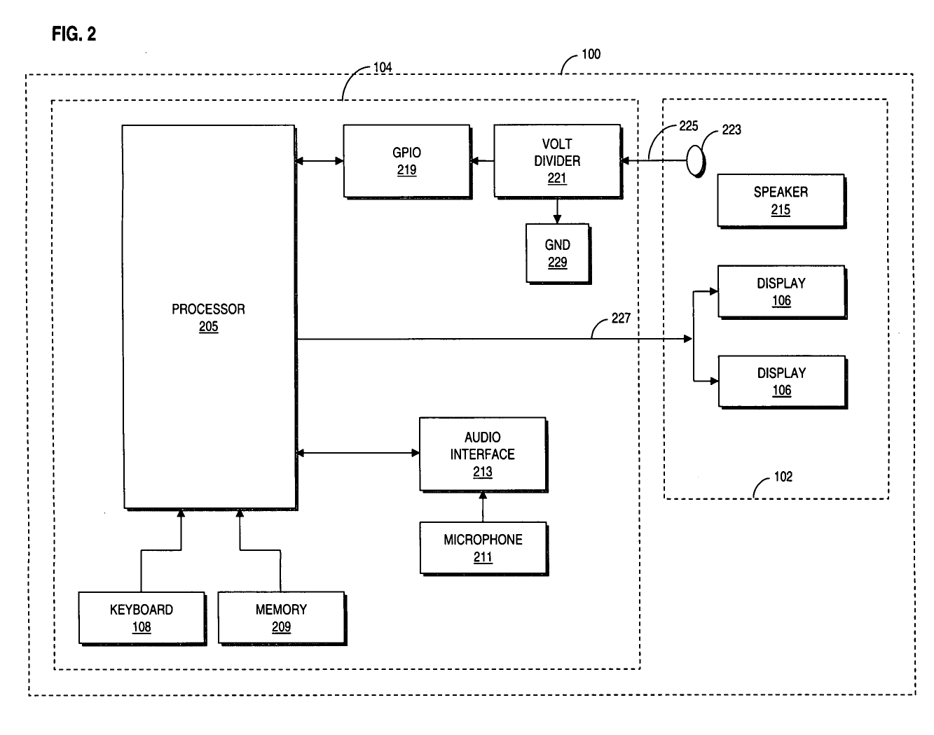

With reference to FIG. 1, a flip-type, or clam-shell, mobile telephone 100 is shown. The telephone has an upper portion 102 and a lower portion 104. In the upper portion 102 is depicted, for illustrative purposes only, two displays 106. However, it should be recognized that there may be only a single display or there may be more than two displays. The lower portion 104 houses, in addition to a keypad 108, the major components of the circuitry necessary to operate the mobile telephone 100, much of which is familiar to skilled artisans and therefore is not specifically shown in the drawings. More detail of the components is shown in FIG. 2.

FIG. 2 is an illustration of the connection between various elements of a mobile telephone 100. In the upper portion 102, as previously discussed, is at least one display 106, in additional to components familiar to those skilled in the art, such as a speaker 215. In accordance with the present disclosure, the upper portion 102 also contains an embedded test point 223. In the lower portion 104 are conventional mobile telephone components, such as processor 205, keyboard 108, memory 209, microphone 211, and audio interface 213, as well as components in accordance with the present disclosure, such as GPIO 219, and voltage divider 221.

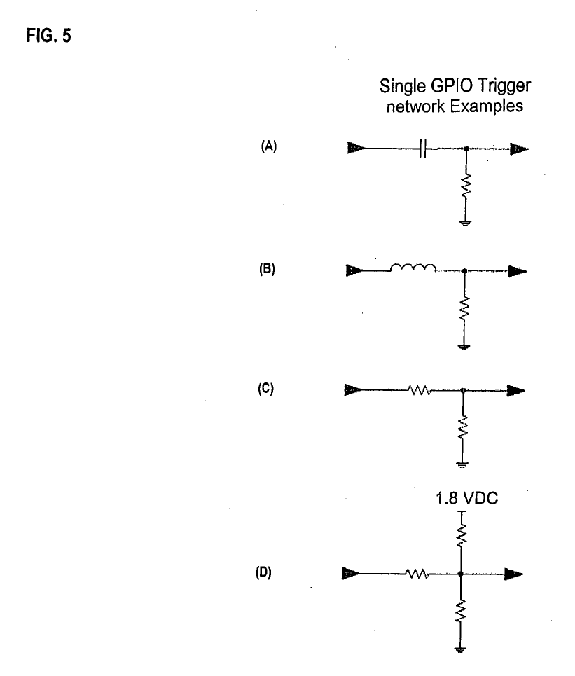

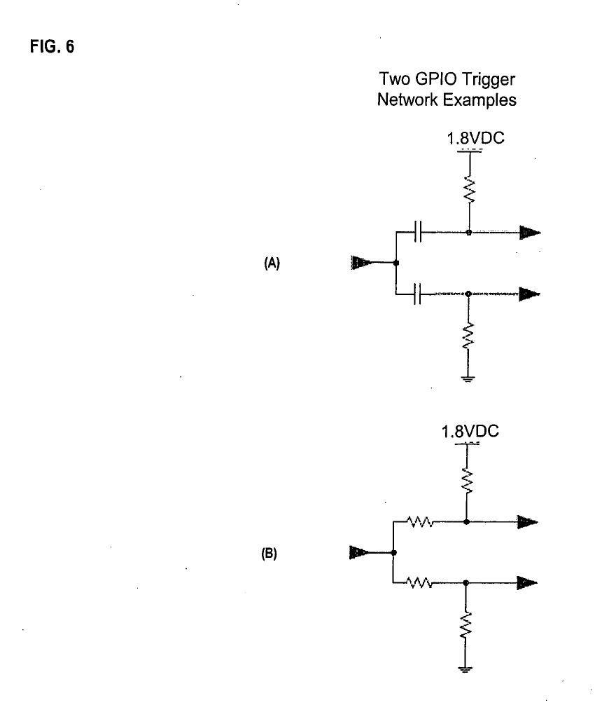

The GPIO 219 is configured as an input with interrupt on a pin state change. GPIO 219 is also connected to a voltage divider trigger 221, shown in more detail in FIGS. 5 and 6, described below. The voltage divider 221 is external to the GPIO 219 and acts to adjust the signal level of any detected ESD and to trigger an interrupt. Since ESD events can result in extremely high voltage, and could easily destroy the delicate circuitry of a mobile telephone, the voltage divider network 221 acts to limit such high transient voltages to a more moderate level acceptable for processing by circuitry of the mobile telephone 100.

A signal track 225, acting as an antenna and ESD detector, is connected from the voltage divider network 221 as an input to GPIO 219, via the connecting flex (not shown) between the upper portion 102 and the lower portion 104 of mobile telephone 100. The signal track 225 terminates at an embedded test point 223 within the upper portion 102. The signal track 225 is preferably constructed of 3 mil copper trace routed through the flex circuit to the upper portion 102 of mobile telephone 100 to the distal end of the displays 106, relative to the lower portion 104. There is no restriction on the routing of the trace comprising the signal track/antenna and it can be routed in any convenient manner through the flex circuit. It is important, however, that the signal track/antenna trace does not connect to any electrical circuits other than GPIO 219 through voltage divider network/trigger network 221. The test point 223 is preferably located in the upper portion 102 of mobile telephone 100 and, more preferably, at a location proximate to the displays 106 and on the distal end of the displays relative to the voltage divider, or trigger network 221, so that an ESD event most likely to affect the displays 106 can more likely be detected. The voltage divider network 221 is connected to ground at 229. Although shown separately from processor 205, GPIO 219 may be a part of processor 205, or GPIO 219 may have its own processing unit.

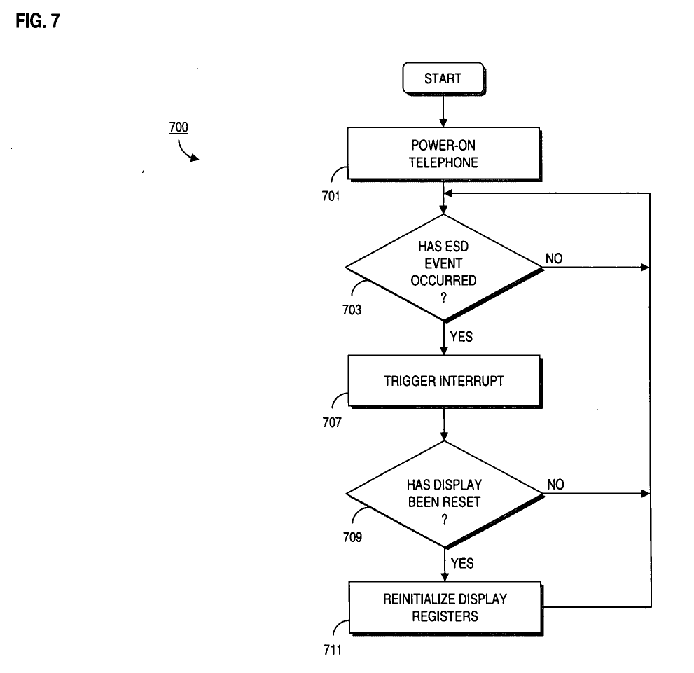

When an ESD event occurs near the displays 106, e.g., at the embedded test point 223, the ESD event causes large transients on the ground plane and the transient signals are coupled into the signal track 225 causing the interrupt to trigger on an GPIO input pin. At this point, a check, or a poll, may be made of the displays 106 by processor 205 via line 227 in order to determine whether any or all of the displays 106 were reset by the ESD event. While this checking procedure may be performed by hardware, e.g., by logic circuits, etc., it is preferably performed by a software implementation. This software implementation is illustrated in FIG. 7. Processor 205 is connected to both the GPIO 219 (in the lower portion 104) and the displays 106 (in the upper portion 102) of the mobile telephone 100. The processor 205 receives the interrupt information from GPIO 219 and the processor polls displays 106 to determine if any displays have been reset by the ESD event. The processor 205 may then send a signal to reinitialize the registers of displays 106 in that event. Alternatively, the processor 205 could send a signal to reinitialize the registers of displays 106 without polling the registers, i.e., it would reinitialize the display registers automatically upon detection of an ESD event.

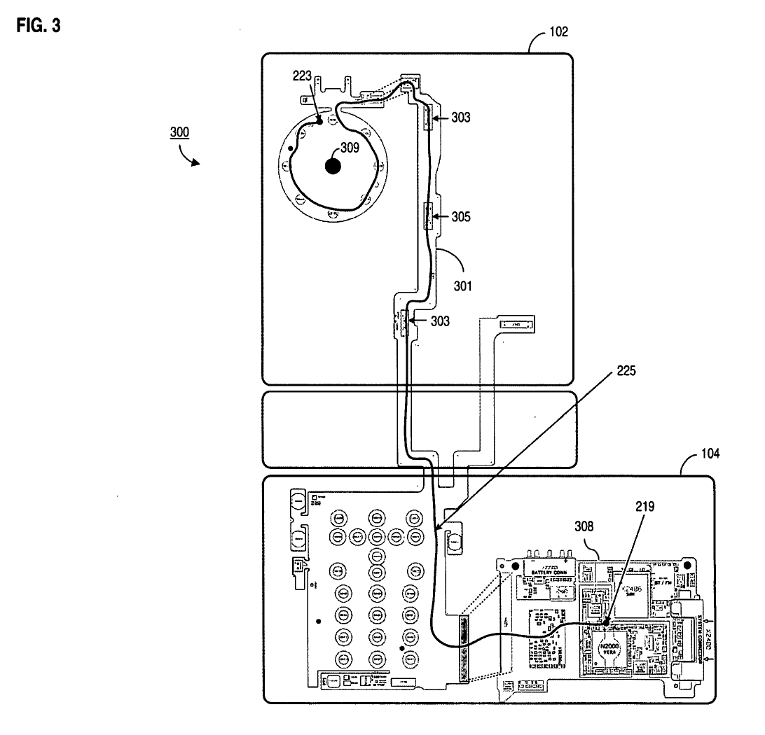

FIG. 3 illustrates a mobile telephone 100 and the connections therein in more detail.

In the upper portion 102 of the mobile telephone, the plurality of displays 106 is shown as 24-pin LCD displays, with a main display 303, a square display 305, and a round display 307. The test point 223 is shown at the upper end of the upper portion 102 further, rather than nearer, the lower portion 104. The various electronic components of the mobile telephone 100 are depicted in detail in FIG. 3, clearly illustrating the relationship between the components on the main printed circuit board 308, where GPIO 219, which may take the form of a processor, is located in the lower portion 104, and the display components 303, 305, and 307, external buttons 309, and test point 223 are located in the upper portion 102. The GPIO 219, in the lower portion 104, is connected to the test point 223, in the upper portion 102, by the signal track/ESD antenna 225. The signal track/ESD antenna 225 is routed via a flex circuit 301 in no particular manner.

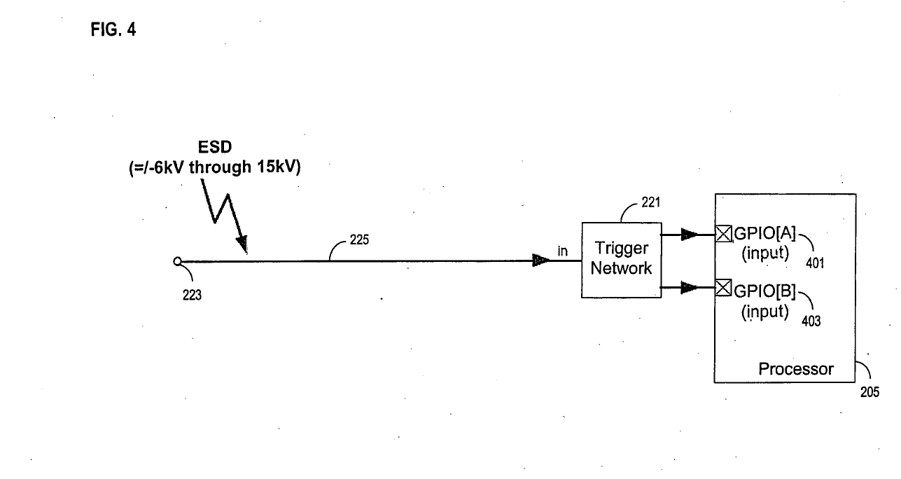

The signal track/ESD antenna 225 is not directly connected to GPIO 219, but, rather, to a triggering network, voltage divider 221 (not shown in FIG. 3). This is depicted in more detail in FIG. 4.

FIG. 4 depicts the connection between the embedded test point 223 and GPIO 219, depicted in FIG. 4 as GPIO inputs 401, 403. A signal track/ESD antenna 225 is connected from test point 223 to trigger network 221. An ESD event may generate a voltage from +/−6 kV to +/−15 kV, or even larger, and travels from the test point 223 along antenna 225 to the trigger network 221. The trigger network 221 is external to the GPIO 219 and may employ one or two GPIOs 401, 403. The GPIOs 401, 403 may be configured as inputs 401, 403 on a processor 205 with no internal pull resistor being active. ESD energy from an ESD event is capacitively coupled to the floating ESD antenna 225, causing the GPIO, or GPIOs, to change state. Moreover, the GPIOs may be configured as a high impedance input and as an interrupt on logic transition (i.e., edge-triggered). When an interrupt is detected, software within the system will either determine if the LCD display registers are corrupted by reading each LCD display to determine if the configuration registers are corrupt, and then reinitialize the display, or simply reinitialize all LCD displays when an ESD event is detected.

As depicted in FIG. 5, a single trigger network, e.g., 221 described above, may take many forms, including an RC network in FIG. 5(a), an LC network in FIG. 5(b), or a resistive network in FIGS. 5 (c) and (d).

FIG. 6 illustrates examples of trigger networks, e.g., 221 described above, when two GPIO triggers are employed, with FIG. 6(a) depicting an RC network and FIG. 6(b) depicting a resistive network.

As depicted in FIG. 7, illustrating a method 700, the process begins with powering-up the mobile telephone at block 701. Then, a determination is made, at decision block 703 as to whether an ESD event has occurred. This determination comprises determining as to whether a transient voltage exceeds a predetermined magnitude. If an ESD event has not occurred, then the process returns to decision block 703, awaiting an ESD event. If an ESD event has occurred (detected, for example, by signal track/antenna/detector 116), then an interrupt is triggered on a GPIO input pin at block 707 and a determination is made, at decision block 709, as to whether a display has been reset as a result of the ESD event. If no display has been reset, then it is assumed that no harm has been done by the ESD event and the process returns to decision block 703 to await an ESD event. If a display has been reset by the ESD event, then the process continues to block 711 where the display registers are reinitialized by resetting the display registers with the original parameters set for display operation, e.g., by powering up the initializing string of parameters. The process then returns to decision block 703 to await a new ESD event.

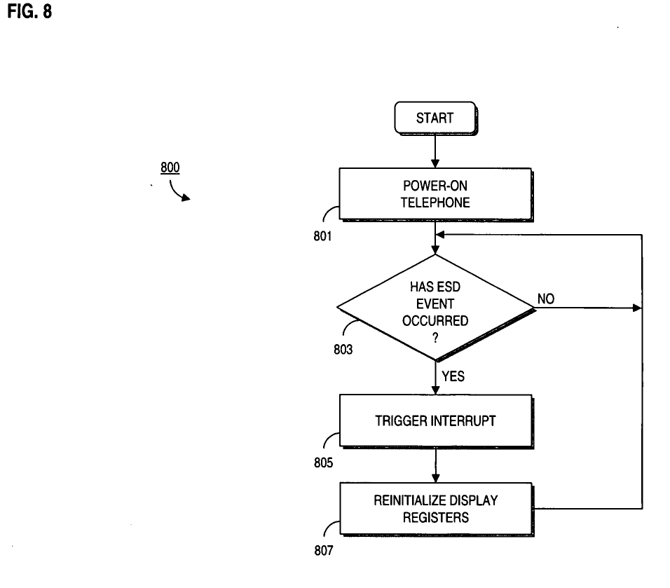

FIG. 8 illustrates a flowchart indicative of another embodiment for controlling the mobile telephone 100. This embodiment is similar to the one depicted in FIG. 7 except that no determination is made as to whether a display has been reset. Rather, the mobile telephone is powered-on at block 801. A determination is then made at block 803 as to whether an ESD event has occurred. If not, the process returns to block 803 waiting for an ESD event to occur. If an ESD event has occurred, the process moves on to block 807 where an interrupt is triggered. Display registers are then reinitialized at block 811 and the process returns to block 803 to await another ESD event. Thus, in this embodiment, an interrupt is triggered and display registers are reinitiated each and every time an ESD event has been detected, regardless of whether a display has been reset by the ESD event. That is, every time an ESD event is detected the display registers would be automatically reinitialized.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and the drawings are accordingly to be regarded in an illustrative rather than restrictive sense.

What is claimed is:

1. A method of controlling a mobile telephone, comprising:
initializing a telephone display;
monitoring a voltage level at a circuit point proximate the display to detect an ESD event; and
reinitializing the display in response to a detection of the ESD event.

2. A method as recited in claim 1, further comprising determining whether a display element has been reset in response to the detected ESD event; and
the reinitializing step is further responsive to a determination that a display element has been reset.

3. A method as recited in claim 1, wherein the step of initializing comprises setting parameters for the display; and
the step of reinitializing comprises restoring the parameters initially set.

4. A method as recited in claim 1, further comprising initiating an interrupt signal when the monitored voltage level exceeds a predetermined threshold level.

5. A method as recited in claim 2, wherein the step of determining comprises polling the status of display registers for indication of any change therein.

6. A method as recited in claim 1, wherein the step of monitoring comprises adjusting the signal level of voltage generated by electrostatic discharge by application of an impedance divider circuit.

7. A method as recited in claim 1, wherein the circuit point is coupled to an antenna of the telephone.

8. A mobile telephone comprising:
at least one display;
means for detecting generation of electrostatic discharge; and
means for adjusting the display in response to detection of a predetermined level of electrostatic discharge.

9. A mobile telephone comprising:
a display;
a processor coupled to the display;
an antenna comprising a signal track connected to a test point;
an impedance circuit connected to the signal track, the impedance circuit coupled to an input of the processor;
wherein the processor is configured to be responsive to at least a threshold voltage at a circuit point in the impedance circuit, generated by an electrostatic discharge on the signal track, to adjust the display.

10. A mobile telephone as recited in claim 9, further comprising a general purpose input/output (GPIO) circuit, the processor coupled to the impedance circuit via the GPIO circuit.

11. A mobile telephone as recited in claim 9, wherein:
the display is formed in a cover member of the telephone;
the processor is contained within a body member of the telephone that is attached to the cover member via a flexible hinged member; and
the test point is formed in the cover member at a location distal from the hinged member.

12. A mobile telephone as recited in claim 11, wherein the signal track traverses both the cover member and the body member via the hinged member, and a portion of the signal track is disposed in proximity to the display.

13. A mobile telephone as recited in claim 11, wherein the impedance circuit is a voltage divider circuit.

14. A mobile telephone as recited in claim 9, wherein the processor is configured to reinitialize the display in response to at least the threshold voltage at the circuit point.

15. A mobile telephone as recited in claim 14, further comprising a plurality of displays, and the processor is configured to reinitialize the plurality of displays.

16. A mobile telephone as recited in claim 9, further including registers coupled to the display, and wherein the processor is further configured to poll the states of the registers in response to the threshold voltage.
